(19) United States
(12) Patent Application Publication
(10) Pub. No.: US 2010/0282094 A1
(43) Pub. Date: Nov. 11, 2010

(54) TURNING TYPE ROAST BOARD

(76) Inventor: Sang Seon Oh, Seoul (KR)

Correspondence Address: CHRISTOPHER PAUL MITCHELL, 888 16TH ST., NW, SUITE 800, WASHINGTON, DC, 20006, US

(21) Appl. No.: 12/810,843

(22) PCT Filed: Dec. 29, 2008
(86) PCT No.: PCT/KR08/07750

§ 371 Date: Jun. 26, 2010

(30) Foreign Application Priority Data
Dec. 27, 2007 (KR) 10-2007-0138770

(51) Int. Cl. A47J 37/06

(52) U.S. Cl. 99/386

(57) ABSTRACT

A replacement type grill device includes a receiving case defined with a supply opening for supplying broiling rods toward feed screws; an inclined vibration plate forming a bottom of the receiving case, located to be inclined toward the supply opening, and having one end which is coupled to an inner sidewall of the receiving case by a hinge to be rotatable in upward and downward directions and the other end which is positioned adjacent to the supply opening of the receiving case and serves as a free end; vibration generation means for vibrating the inclined vibration plate in response to rotation of a feed control lever and thereby vibratorily accomplishing arrangement of the broiling rods; and arrangement means installed on another inner sidewall of the receiving case to limit a gap between the inclined vibration plate and the arrangement means so that individual supply of broiling rods can be ensured.

### TECHNICAL FIELD

The present invention relates to a replacement type grill device which is constructed such that a grill composed of a plurality of broiling rods can be changed by manipulating a lever, and more particularly, to a replacement type grill device which is constructed such that vibrations are generated when manipulating a lever so that broiling rods can be quickly and reliably arranged and the stable supply of the broiling rods can be ensured, thereby improving user convenience.

### BACKGROUND ART

Generally, the charcoal broiling utensils currently used in restaurants, etc. simply comprise circular or rectangular gridirons. When such conventional gridirons are used as charcoal broiling utensils, gridirons should usually be changed about three or four times to prevent meat from burning. Thus, inconvenience is caused due to the frequent changing of the gridirons, and an accident is likely to occur while a service worker is changing the gridirons. Further, there exist other problems such as customers' dissatisfaction due to delayed change of the gridirons and increased personnel expenses due to an increase in the number of service workers.

Moreover, additional service workers are needed to wash the gridirons. Also, since the gridirons should be manually washed one by one, lots of labor and working hours are required due to difficulties in washing the gridirons, whereby management costs increase.

Meanwhile, in the case of charcoal broiling utensils used for outdoor barbecue cooking, they comprise simple grills which have a form similar to the aforementioned gridirons. Even in these grills, in order to prevent meat from burning, it is required to change the grills. However, since it is difficult to prepare additional grills, the grills are usually used continuously without being changed. Also, it is difficult to wash the grills.

In order to cope with these problems, the present applicant had disclosed Korean Patent No. 600657 entitled “A Replacement Type Grill Device.”

Referring to FIGS. 1 and 2, the replacement type grill device disclosed by the present applicant generally comprises a grill device body 100, a broiling rod supply unit 200, a broiling rod receiving and discharging unit 300, and a broiling rod moving unit 400.

The grill device body 100 has a case 102 formed at one end thereof. Below the case 102, a feed control lever 107 for controlling the feed of broiling rods 106 is installed on one side surface of the grill device body 100. A brazier unit 108, in which a brazier is placed, is disposed in the space defined in the grill device body 100.

The broiling rod supply unit 200 functions to supply the individual broiling rods 106 one by one. The broiling rod supply unit 200 comprises a pair of broiling rod supply plates 202 which face each other. Each of the broiling rod supply plates 202 is structured to define a supply path 201 for supplying the broiling rods 106, in a zigzag pattern, such that the supply path 201 is inclined at a predetermined angle so as to prevent the broiling rods 106 from being obstructed in movement or caught in the supply path 201. The supply path 201 has the sectional shape of a hopper in which the upper end is wide and a supply opening 203 defined at the lower end is narrow.

The broiling rod receiving and discharging unit 300 takes the shape of a case for receiving used broiling rods 106 and is detachably installed on the other end of the grill device body 100 which has the case 102 formed at the one end thereof.

The broiling rod moving unit 400 comprises gear means 401 which is coupled to and integrally rotated with the feed control lever 107, and screws 406 each of which has one end meshed with the gear means 401 and the other end rotatably supported by the other end of the grill device body 100 where the broiling rod receiving and discharging unit 300 is arranged. The screws 406 are horizontally installed on opposite ends of the grill device body 100 in a manner such that the broiling rods 106 can be moved by the rotation of the screws 406.

In the replacement type grill device disclosed by the present applicant and constructed as mentioned above, when it is necessary to change the broiling rods 106 while broiling meat using a charcoal fire, the supply of the broiling rods 106 can be implemented by a user's simple manipulation of the feed control lever 107 which is installed on the grill device body 100.

In the replacement type grill device disclosed by the present applicant, the broiling rod supply unit 200 is configured such that the broiling rods 106 can be supplied through the supply openings 203 after being passed through the supply paths 201 defined zigzag in the broiling rod supply plates 202 and inclined at the predetermined angle. However, in this regard, if two or more broiling rods 106 interfere with one another at entrances into the supply paths 201 of the broiling rod supply plates 202, the smooth introduction of the broiling rods 106 into the supply paths 201 is likely to be impeded, resulting in user inconvenience.

Moreover, in the replacement type grill device, in an effort to decrease the height of the broiling rod supply unit 200, zigzag grooves, that is, the supply paths 201 are defined in the broiling rod supply plates 202 to be inclined at a gentle slope. Therefore, since the inclination angle of the supply paths 201 has a gentle slope, the movability of the broiling rods 106 is likely to deteriorate. Also, due to the presence of water which has adhered to the broiling rods 106 as a result of a washing process, surface friction between the broiling rods 106 increases, as a result of which the smooth movement and supply of the broiling rods 106 are likely to be retarded, whereby user inconvenience can result.

### DISCLOSURE OF INVENTION

### Technical Problem

Accordingly, the present invention has been made in an effort to solve the problems occurring in the related art, and an object of the present invention is to provide a replacement type grill device which is constructed such that an inclined vibration plate as a whole can be vibrated in synchrony with the manipulation of a feed control lever so that the broiling rods placed on the inclined vibration plate can be quickly and reliably arranged and stably supplied, whereby the operational reliability of the replacement type grill device can be improved when changing a grill.

### Technical Solution

In order to achieve the above object, according to one aspect of the present invention, there is provided a replacement type grill device including a grill device body which has a broiling space over which broiling rods are horizontally placed at regular intervals to constitute a grill and in which a heating source is disposed, the grill device body possessing a feed control lever which is provided on one side surface of the grill device body and which is connected to a rotation shaft installed in a widthwise direction of the grill device body, a supply unit which is installed at one end of the grill device body to individually supply broiling rods toward the broiling space, a discharging unit which is installed at the other end of the grill device body to receive used broiling rods, and a moving unit which is connected to the feed control lever through gear meshing, is positioned between the supply unit and the discharging unit and has feed screws for feeding broiling rods inserted into spiral grooves defined thereon, the grill device comprising a receiving case defined with a supply opening for supplying broiling rods stored therein toward the feed screws; an inclined vibration plate forming a bottom of the receiving case, and located to be inclined toward the supply opening; vibration generation means for vibrating the inclined vibration plate upward and downward in response to rotation of the feed control lever and thereby vibratorily accomplishing arrangement of the broiling rods; and arrangement means installed on another inner sidewall of the receiving case to limit a gap between the inclined vibration plate and the arrangement means so that individual supply of the broiling rods can be ensured.

According to another aspect of the present invention, the inclined vibration plate has one end which is coupled to an inner sidewall of the receiving case by a hinge to be rotatable in upward and downward directions and the other end which is positioned adjacent to the supply opening of the receiving case and serves as a free end.

According to another aspect of the present invention, the vibration generation means comprises a rotary vibration cam coupled to the rotation shaft; a bearing brought into rolling contact with the rotary vibration cam to be raised and lowered by the rotary vibration cam; and a bracket connecting the bearing to a lower surface of the inclined vibration plate.

According to still another aspect of the present invention, the arrangement means comprises guide stoppers installed on another inner sidewall of the receiving case and having surfaces which are inclined toward the inclined vibration plate to allow the gaps between the guide stoppers and the inclined vibration plate to gradually decrease toward the supply opening.

According to a still further aspect of the present invention, at least two guide stoppers are provided to be separated by a predetermined distance, and an elongate elastic plate is connected between the guide stoppers.

The above objects, and other features and advantages of the present invention will become more apparent after a reading of the following detailed description taken in conjunction with the drawings. Before describing the embodiments of the present invention, it is to be understood that the terms or words used in this description and the following claims must not be construed to have meanings which are general or can be found in a dictionary. Therefore, considering the notion that an inventor can most properly define the concepts of the terms or words to best explain his or her invention, the terms or words must be understood as having meanings or concepts that conform to the technical spirit of the present invention.

### ADVANTAGEOUS EFFECTS

Thanks to the features of the replacement type grill device according to the present invention, the quick and reliable planar arrangement of a plurality of broiling rods placed on an inclined vibration plate can be enabled by simple manipulation of rotating a feed control lever in such a way as to apply a user's manipulation force to the feed control lever. Also, due to the presence of guide stoppers which define the upper end of a supply opening, the broiling rods can be guided to be individually supplied so that the stable supply of the broiling rods can be ensured, whereby the convenience of the user and the operational reliability of the replacement type grill device can be improved.

Thus, in the replacement type grill device to which a novel broiling rod supply unit is applied according to the present invention, when broiling meat using a charcoal fire, it is possible to solve the problems of inconvenience being caused and an accident occurring due to the frequent changing out of a grill. Further, the broiling rods constituting the grill can be easily washed so that convenience in the use of the replacement type grill device can be ensured and the replacement type grill device can always be kept clean.

### BRIEF DESCRIPTION OF DRAWINGS

FIG. 1 is a perspective view illustrating a conventional replacement type grill device;

FIG. 2 is a side sectional view illustrating the construction of the conventional replacement type grill device;

FIG. 3 is a plan view illustrating the construction of a broiling rod supply unit of a replacement type grill device in accordance with an embodiment of the present invention;

FIG. 4 is a front sectional view illustrating the construction of the broiling rod supply unit of the replacement type grill device in accordance with the embodiment of the present invention; and

FIG. 5 is a side sectional view illustrating the construction of the broiling rod supply unit of the replacement type grill device in accordance with the embodiment of the present invention.

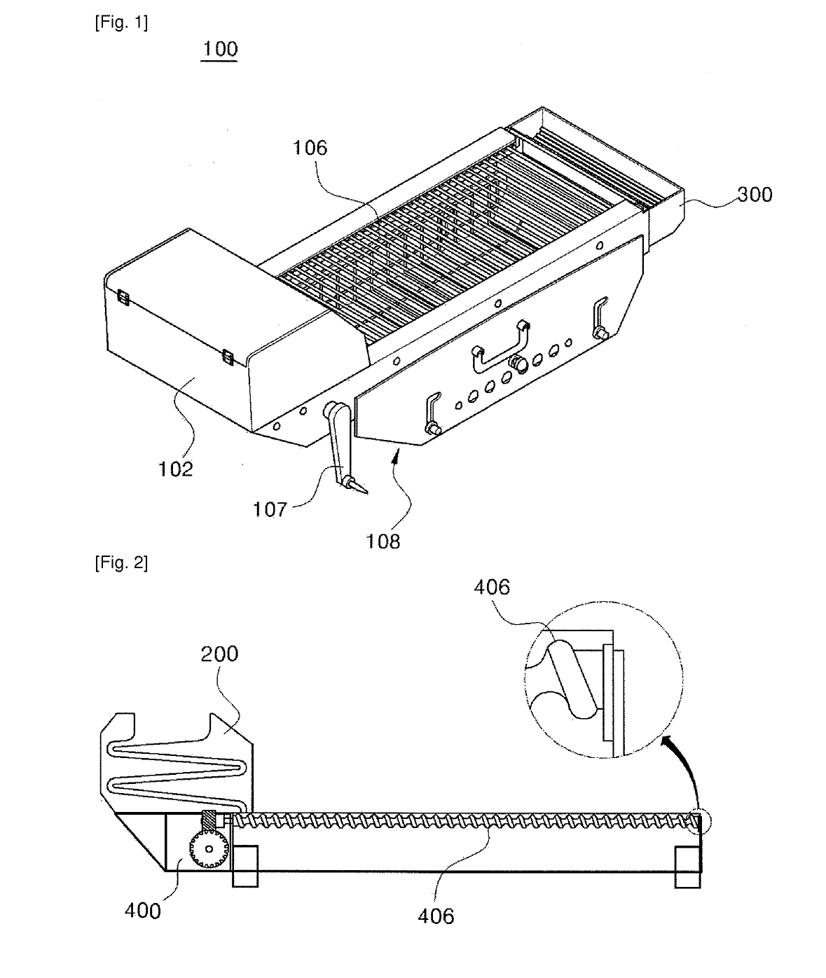

<Description of Reference Numerals for Main Parts in Drawings>
1: grill device 3: grill device body
5: supply unit 7: discharging unit
9: moving unit 9a: gears
9b: feed screws 10: receiving case
11: entrance 13: supply opening
20: inclined vibration plate
21: hinges 30: vibration generation means
31: rotary vibration cam
33: bearing 35: bracket
40: arrangement means 41: guide stoppers

### MODE FOR THE INVENTION

Hereafter, a replacement type grill device in accordance with a preferred embodiment of the present invention will be described with reference to the accompanying drawings.

First, the same reference numerals will be used throughout the drawings and the description to refer to the same or like parts. In the following description of the present invention, the detailed description of known functions and configurations incorporated herein will be omitted in order not to make the subject matter of the present invention unclear.

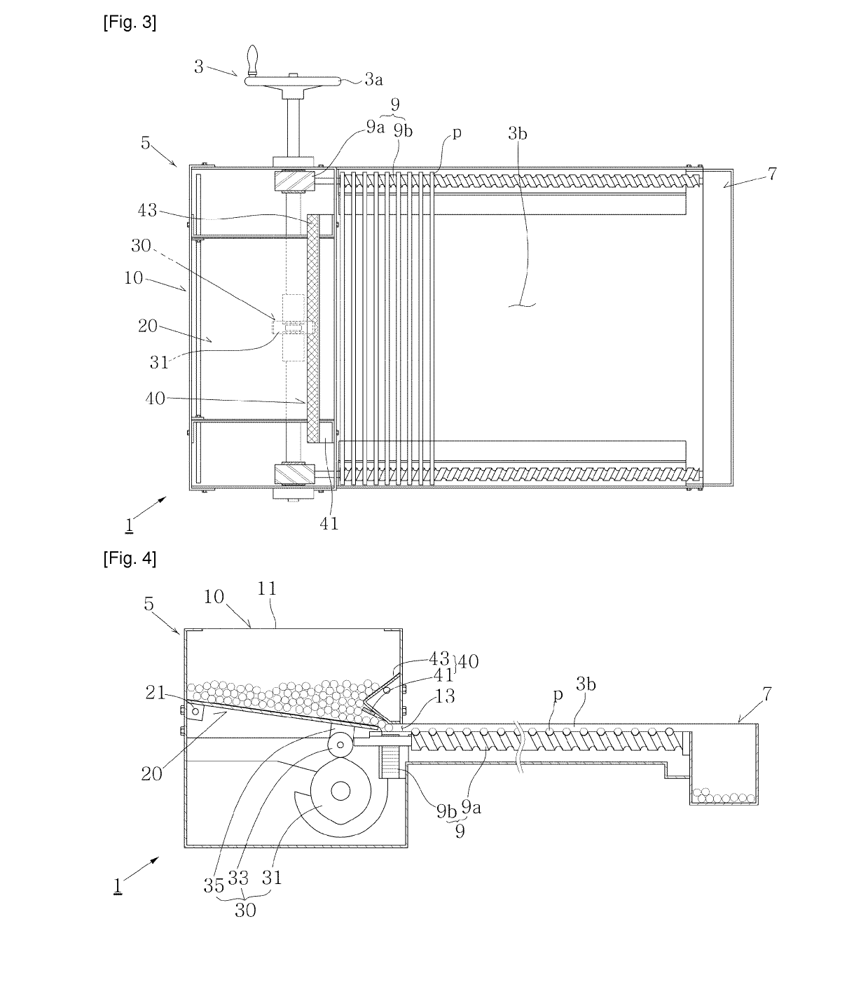

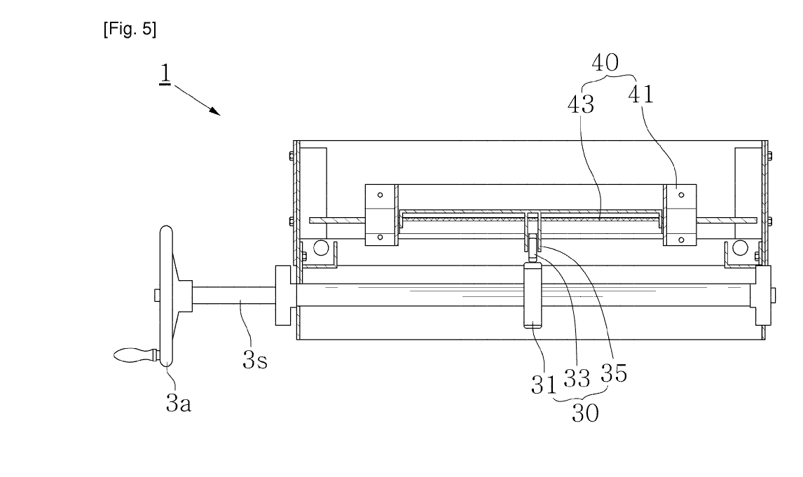

FIG. 3 is a plan view illustrating the construction of a broiling rod supply unit of a replacement type grill device in accordance with an embodiment of the present invention, FIG. 4 is a front sectional view illustrating the construction of the broiling rod supply unit of the replacement type grill device in accordance with the embodiment of the present invention, and FIG. 5 is a side sectional view illustrating the construction of the broiling rod supply unit of the replacement type grill device in accordance with the embodiment of the present invention.

Referring to FIGS. 3 through 5, a replacement type grill device 1 in accordance with an embodiment of the present invention generally includes a grill device body 3, a supply unit 5 for sequentially supplying a plurality of broiling rods p, a discharging unit 7 for discharging the broiling rods p supplied by the supply unit 5 and then used, and a moving unit 9 for moving the broiling rods p in one direction.

The grill device body 3 is composed of a casing which provides a space for mounting various component elements. The grill device body 3 defines a broiling space 3b for broiling meat or other food. The broiling rods p taking the shape of a round bar and having a predetermined length are horizontally placed over the broiling space 3b in such a way as to constitute a grill.

A heating source such as a charcoal burner, a gas burner and an electric range is disposed in the broiling space 3b as an element for applying heat to meat or other food. A feed control lever 3a is provided on one side surface of the grill device body 3 as an element for controlling the feed of the broiling rods p in one direction in response to the application of manipulation force by a user. As can be readily seen from the drawings, the feed control lever 3a is located in the widthwise direction of the grill device body 3 and is connected to a rotation shaft 3s which is rotatably disposed.

The supply unit 5 is provided at one end of the grill device body 3 and has a supplying element which can supply the plurality of broiling rods p. The supply unit 5 functions to individually feed the supplied broiling rods p toward the broiling space 3b in response to the rotary manipulation of the feed control lever 3a. By the provision of the supply unit 5, the broiling rods p supplied toward the broiling space 3b defined in the grill device body 3 can be fed toward the broiling space 3b along the spiral grooves defined on feed screws 9b which constitute the moving unit 9 as will be described later.

The discharging unit 7 is provided at the other end of the grill device body 3 opposite the supply unit 5 and serves as an element for collecting and discharging used broiling rods p. That is to say, the discharging unit 7 is provided to collect the broiling rods p which have been arranged over the broiling space 3b and on which the meat or other food has been placed and broiled. The discharging unit 7 comprises a case for receiving the plurality of used broiling rods p.

The moving unit 9 is composed of gears 9a which are coupled to a rotation shaft 3s of the feed control lever 3a provided on one side surface of the grill device body 3 and the feed screws 9b which are meshed with the gears 9a to be rotated thereby. Each feed screw 9b takes the shape of a round bar which possesses a preset length and has the spiral groove defined on the circumferential outer surface thereof. The spiral groove of the feed screw 9b is defined to have a pitch that allows the broiling rods p to be inserted into and held in the spiral groove. The feed screws 9b are located in such a way as to connect the supply unit 5 and the discharging unit 7 with each other. At least two feed screws 9b are located at regular intervals so as to stably feed the broiling rods p.

The gears 9a serve as elements for transmitting the rotational force of the rotation shaft 3s which is rotatably installed in the widthwise direction of the grill device body 3, to the feed screws 9b. The gears 9a comprise direction changing gears which are well known in the art.

In the replacement type grill device constructed as mentioned above, since the component elements excluding the supply unit 5, that is, the grill device body 3, the discharging unit 7 and the moving unit 9 can be structured in the same way as the conventional art, the detailed descriptions thereof will be omitted herein. Here, the conventional art indicates the replacement type grill device which had been disclosed by the present applicant and is aforementioned in the ‘background art’ section.

Therefore, the present invention can be characterized by the fact that the supply unit 5 is provided such that the plurality of broiling rods p can be quickly and reliably arranged and can be stably supplied toward the broiling space 3b one by one.

The supply unit 5 according to the present invention includes a receiving case 10 into and in which the plurality of broiling rods p are introduced and stored and which is defined with a supply opening 13 for supplying the broiling rods p toward the broiling space 3b, an inclined vibration plate 20 which forms the bottom of the receiving case 10, is located to be inclined toward the supply opening 13 and has one end hinged to the receiving case 10, vibration generation means 30 which transmits the rotary manipulation force of the feed control lever 3a to the inclined vibration plate 20, and arrangement means 40 which is installed on the inner sidewall of the receiving case 10 above the supply opening 13 so as to allow the broiling rods p to be individually supplied toward the broiling space 3b through the supply opening 13 one by one.

Preferably, the receiving case 10 is formed of a plate made of a metal such as stainless steel, which has excellent corrosion resistance and machinability.

The receiving case 10 has the shape of a box which is defined with an introduction opening 11 through the upper wall thereof. A cover (not shown) can be provided to the upper wall of the receiving case 10 to selectively open and close the introduction opening 11. The supply opening 13 is defined to allow the stored broiling rods p to be supplied toward the broiling space 3b. It is preferred that the supply opening 13 have a size for permitting the passage of only one broiling rod p.

The inclined vibration plate 20 comprises a plate-shaped member which forms the bottom of the receiving case 10. As can be readily seen from the drawings, the inclined vibration plate 20 is located to be inclined downward toward the supply opening 13 of the receiving case 10 and has a structure in which one end thereof is coupled to the receiving case 10 by a hinge 21.

Due to the fact that the inclined vibration plate 20 is located to be inclined downward toward the supply opening 13, the broiling rods p stored in the receiving case 10 can be moved toward the supply opening 13 by their own weights.

In the state in which the inclined vibration plate 20 is inclined downward, the inclined vibration plate 20 can be fluctuated up and down by the vibration generation means 30 which will be described below. By the upward and downward fluctuation of the inclined vibration plate 20, the vibratory arrangement of the plurality of broiling rods p placed on the inclined vibration plate 20 can be accomplished.

The vibration generation means 30 serves as an element for generating vibration force for fluctuating the inclined vibration plate 20 upward and downward. As shown in the drawings, the vibration generation means 30 includes a rotary vibration cam 31 which is coupled to the rotation shaft 3s connected to the feed control lever 3a, a bearing 33 which is a rotation member configured to be brought into rolling contact with the rotary vibration cam 31, and a bracket 35 which is fastened to the lower surface of the inclined vibration plate 20 and rotatably supports the bearing 33.

That is to say, as can be readily seen from the drawings, the rotary vibration cam 31 has a disc-shaped configuration and is formed with at least one protrusion on the circumferential outer surface thereof. The bearing 33 is a member which is rotated while being brought into rolling contact with the outer surface of the rotary vibration cam 31. As the bearing 33 is brought into rolling contact with the protrusion of the rotary vibration cam 31, the bearing 33 vibrates in the vertical direction. Due to the fact that the bracket 35 is fastened to the lower surface of the inclined vibration plate 20 and rotatably supports the bearing 33, the vibrations of the bearing 33 can be transmitted to the inclined vibration plate 20.

When the broiling rods p vibratorily arranged on the inclined vibration plate 20 are moved toward the supply opening 13 of the receiving case 10, the arrangement means 40 serves as an element for limiting a supply angle so that the broiling rods p can be supplied through the supply opening 13 one by one.

The arrangement means 40 includes guide stoppers 41 which are fastened to the inner sidewall of the receiving case 10 above the supply opening 13 and has a surface inclined toward the inclined vibration plate 20 to allow the gaps between the guide stoppers 41 and the inclined vibration plate 20 to gradually decrease toward the supply opening 13, and an elongated elastic plate 43 which is connected to the guide stoppers 41 at one end thereof.

As shown in the drawings, each guide stopper 41 comprises a member which is fastened to the inner sidewall of the receiving case 10 and has a triangular sectional shape. The guide stoppers 41 are positioned above the supply opening 13 of the receiving case 10.

A pair of guide stoppers 41 are positioned to be separated by a predetermined distance. The elongate elastic plate 43 is positioned between and is connected to the guide stoppers 41. As shown in the drawings, the elongate elastic plate 43 has one end which is positioned adjacent to the supply opening 13 and is coupled to the lower surfaces of the guide stoppers 41 and the other end which serves as a free end.

Hereinbelow, the function of the replacement type grill device according to the present invention, constructed as mentioned above, will be described.

First, in order to place meat or other food over the broiling space 3b of the grill device body 3, the feed control lever 3a provided on one surface of the grill device body 3 is grasped and rotated in one direction.

Then, by the rotary manipulation force of the feed control lever 3a, the feed screws 9b located over the broiling space 3b are rotated, and at the same time, the broiling rods p stored in the receiving case 10 are inserted one by one through the supply opening 13 into the spiral grooves defined on the outer surfaces of the feed screws 9b to be fed toward the broiling space 3b.

Accordingly, the broiling rods p stored in the receiving case 10 can be placed over the broiling space 3b through a user's simple rotation of the feed control lever 3a and can constitute a grill. When it is necessary to replace the plurality of broiling rods p placed over the broiling space 3b, by rotating the feed control lever 3a in the same manner, new broiling rods p stored in the receiving case 10 can be fed toward the broiling space 3b, and the used broiling rods p placed over the broiling space 3b can be moved and received in the discharging unit 7.

The broiling rods p stored in the receiving case 10 are supplied through the supply opening 13 of the receiving case 10 onto the feed screws 9b one by one by virtue of the inclined vibration plate 20, the vibration generation means 30 and the arrangement means 40 as the characterizing features of the present invention.

In other words, when the user rotates the feed control lever 3a and feeds the broiling rods p toward the broiling space 3b, the rotary vibration cam 31 coupled to the rotation shaft 3s connected to the feed control lever 3a is integrally rotated. Due to this fact, the inclined vibration plate 20 can be vibrated up and down via the bearing 33 brought into rolling contact with the outer surface of the rotary vibration cam 31 and the bracket 35 supporting the bearing 33.

Thus, the vibratory arrangement of the plurality of broiling rods p can be accomplished by the vibration of the inclined vibration plate 20 having the broiling rods p placed thereon.

Furthermore, since the broiling rods p can be supplied one by one due to the presence of the pair of guide stoppers 41 coupled to the inner sidewall of the receiving case 10 and the gap between the elastic plate 43 connecting the guide stoppers 41 and the inclined vibration plate 20, the stable discharge of the broiling rods p can be ensured.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A replacement type grill device including a grill device body which has a broiling space over which broiling rods are horizontally placed at regular intervals to constitute a grill and in which a heating source is disposed, the grill device body possessing a feed control lever which is provided on one side surface of the grill device body and is connected to a rotation shaft installed in a widthwise direction of the grill device body, a supply unit which is installed at one end of the grill device body to individually supply broiling rods toward the broiling space, a discharging unit which is installed at the other end of the grill device body to receive used broiling rods, and a moving unit which is connected to the feed control lever through gear meshing, is positioned between the supply unit and the discharging unit and has feed screws for feeding broiling rods inserted into spiral grooves defined thereon, the grill device comprising:
a receiving case defined with a supply opening for supplying broiling rods stored therein toward the feed screws;
an inclined vibration plate forming a bottom of the receiving case, located to be inclined toward the supply opening, and having one end which is coupled to an inner sidewall of the receiving case by a hinge to be rotatable in upward and downward directions and the other end which is positioned adjacent to the supply opening of the receiving case and serves as a free end;
vibration generation means for vibrating the inclined vibration plate upward and downward in response to rotation of the feed control lever and thereby vibratorily accomplishing arrangement of the broiling rods; and
arrangement means installed on another inner sidewall of the receiving case to limit a gap between the inclined vibration plate and the arrangement means so that individual supply of the broiling rods can be ensured.

2. The replacement type grill device according to claim 1, wherein the vibration generation means comprises:
a rotary vibration cam coupled to the rotation shaft;
a bearing brought into rolling contact with the rotary vibration cam to be raised and lowered by the rotary vibration cam; and
a bracket connecting the bearing to a lower surface of the inclined vibration plate.

3. The replacement type grill device according to claim 1, wherein the arrangement means comprises:
guide stoppers installed on another inner sidewall of the receiving case and having surfaces which are inclined toward the inclined vibration plate to allow the gaps between the guide stoppers and the inclined vibration plate to gradually decrease toward the supply opening.

4. The replacement type grill device according to claim 3, wherein at least two guide stoppers are provided to be separated by a predetermined distance, and an elongated elastic plate is connected between the guide stoppers.
